(19) United States
(12) Patent Application Publication
(10) Pub. No.: US 2025/0308145 A1
(43) Pub. Date: Oct. 2, 2025

(54) Real Time Iris Detection and Augmentation

(71) Applicant: Apple Inc., Cupertino, CA (US)

(72) Inventor: Long H. Ngo, San Jose, CA (US)

(21) Appl. No.: 19/019,815

(22) Filed: Jan. 14, 2025

Related U.S. Application Data
(60) Provisional application No. 63/569,987, filed on Mar. 26, 2024.

(51) Int. Cl. G06T 15/50; G06T 7/90; G06V 10/22; G06V 40/18

(52) U.S. Cl. CPC G06T 15/50; G06T 7/90; G06V 10/225; G06V 40/18

(57) ABSTRACT

Realistic eye reflections are created for a virtual representation of a subject based on the lighting conditions defined by an environmental map. For each eye of a subject, a set of markers are tracked which are associated with landmarks of the subject's eyes. From the markers, a region corresponding to the opening of the eyes is determined. Within the region corresponding to the opening of the eyes, an iris region is identified. A lighting effect is applied to the iris portion of the eyes. An environmental map defining the lighting of a particular environment can be used to adjust the appearance of the iris region of the eyes. A brightness in the iris region may be adjusted to cause the eyes to have a glimmer corresponding to the lighting in the environment, thereby causing a more realistic appearance of the eyes.

### BACKGROUND

Computerized characters that represent and are controlled by users are commonly referred to as avatars. Avatars may take a wide variety of forms, including virtual humans, animals, and plant life. Some computer products include avatars with facial expressions that are driven by a user's facial expressions. One use of facially-based avatars is in communication, where a camera and microphone in a first device transmits audio and a real-time 2D or 3D avatar of a first user to one or more second users, such as other mobile devices, desktop computers, videoconferencing systems, and the like. Eyes are one of the most expressive and important features of the human face, and they convey a lot of information about the emotions, intentions, and attention of a person. Therefore, creating realistic eyes for avatars can enhance the immersion and interaction in virtual environments.

### BRIEF DESCRIPTION OF THE DRAWINGS

FIG. 1 shows an example flow diagram of a technique for rendering a virtual representation of eyes of a subject, in accordance with one or more embodiments.

FIG. 2 shows an example flow diagram of a technique for applying a lighting effect to an iris region of a virtual representation of the eyes of the subject, in accordance with one or more embodiments.

FIG. 3 shows, in flow diagram form, a technique for generating a target texture, in accordance with one or more embodiments.

FIG. 4 shows a diagram of a head mounted device, in accordance with one or more embodiments.

FIG. 5 shows a flow diagram of a technique for rendering a persona in a multiuser communication session, in accordance with one or more embodiments.

FIG. 6 shows, in block diagram form, a multifunction electronic device, in accordance with one or more embodiments.

FIG. 7 shows, in block diagram form, a computer system, in accordance with one or more embodiments.

### DETAILED DESCRIPTION

This disclosure relates generally to image processing. More particularly, but not by way of limitation, this disclosure relates to techniques and systems for generating and utilizing machine learning for rendering an avatar.

Embodiments described herein are directed to creating realistic eye reflections in a virtual character based on the lighting conditions defined by an environmental map. For each eye of a subject, a set of markers are tracked. The set of markers may be associated with landmarks on the eyes of the subject, such as the corners of the eyes, and a top and bottom location of the openings of the eyes. From the markers, a region corresponding to the opening of the eyes is determined, for example using polynomial interpolation. Within the region corresponding to the opening of the eyes, an iris region may be identified, for example based on a color differential within the opening of the eyes. A lighting effect is applied to the iris portion of the eyes. For example, an environmental map defining the lighting of a particular environment can be used to adjust the appearance of the iris region of the eyes. For example, a brightness in the iris region may be adjusted to cause the eyes to have a glimmer corresponding to the lighting in the environment, thereby causing a more realistic appearance of the eyes. Additionally, or alternatively, a visual artifact may be applied to the eyes to introduce a glimmer or other feature to cause a more realistic appearance of the eyes.

There are numerous technical benefits for utilizing the embodiments described herein to render an eye region of a persona. One of the technical benefits of using markers to interpolate the location of an eye rather than using a machine learning model for eye and iris segmentation is that computational complexity and latency of the eye tracking system are reduced. Markers can provide a simple and robust way to estimate a shape of the eye region based on the relative distances and angles between the markers and the camera. Further, applying the lighting effect to the identified portion of the eye provides an efficient manner in producing photorealistic virtual representations of a subject while conserving computational resources.

A physical environment refers to a physical world that people can sense and/or interact with without aid of electronic devices. The physical environment may include physical features such as a physical surface or a physical object. For example, the physical environment may correspond to a physical park that includes physical trees, physical buildings, and physical people. People can directly sense and/or interact with the physical environment such as through sight, touch, hearing, taste, and smell. In contrast, an extended reality (XR) environment refers to a wholly- or partially-simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

For purposes of this disclosure, an autoencoder refers to a type of artificial neural network used to fit data in an unsupervised manner. The aim of an autoencoder is to learn a representation for a set of data in an optimized form. An autoencoder is designed to reproduce its input values as outputs, while passing through an information bottleneck that allows the dataset to be described by a set of latent variables. The set of latent variables are a condensed representation of the input content, from which the output content may be generated by the decoder. A trained autoencoder will have an encoder portion, a decoder portion, and the latent variables represent the optimized representation of the data.

For purposes of this disclosure, the term “persona” refers to a photorealistic virtual representation of a real-world subject, such as a person, animal, plant, object, and the like. The real-world subject may have a static shape, or may have a shape that changes in response to movement or stimuli.

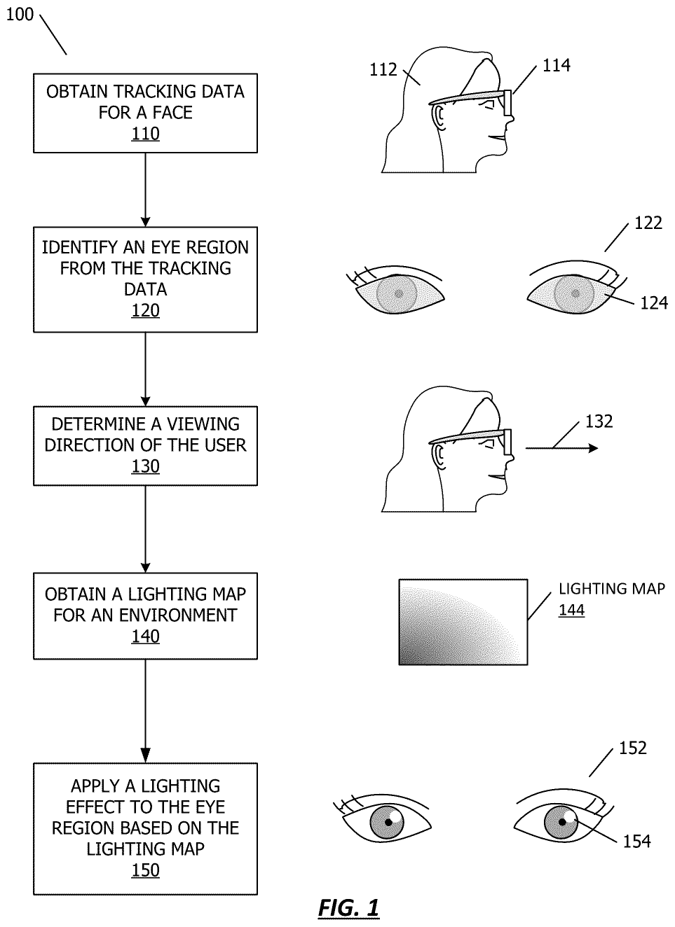

FIG. 1 shows an example flow diagram of a technique for rendering a virtual representation of eyes of a subject, in accordance with one or more embodiments. In particular, the flow diagram shows an example series of steps which are used to apply a lighting effect to eyes of a persona, along with example diagrams for each step in the process. Although the various process depicted in FIG. 1 are illustrated in a particular order, it should be understood that the various processes described may be performed in a different order. Further, not all of the various processes may be necessary to be performed to train the mesh and texture encoders and decoders or obtain lighting representations.

The flow diagram 100 begins at block 110, where tracking data for a face is obtained. According to one or more embodiments, a local device, such as head mounted device 114 can run a face tracking algorithm. The face tracking technique may include, for example, applying image data and/or other sensor data captured by the local device 114 to obtain information about the pose or other characteristics of the user 112. In some embodiments, the face tracking technique may include applying the sensor data to an expression model to obtain a set of expression latents for an expression by the user in the particular frame. As another example, for each frame of tracking data, a height field displacement map may be generated and provide RGB values, along with depth values and alpha values. The displacement map may include additional information, such as location of certain features of the user in the form of semantic markers. Other information determined from the tracking data may include, for example, a position and orientation of a head, a location of a head, and the like.

Further, in some embodiments, eye tracking may be performed. According to one or more embodiments, the tracking data may additionally include eye tracking data. In some embodiments, the eye tracking process may include capturing image data and/or other sensor data of each eye to determine characteristics of the eye. Characteristics determined from the tracking data may include, for example, gaze direction, eye location, and the like.

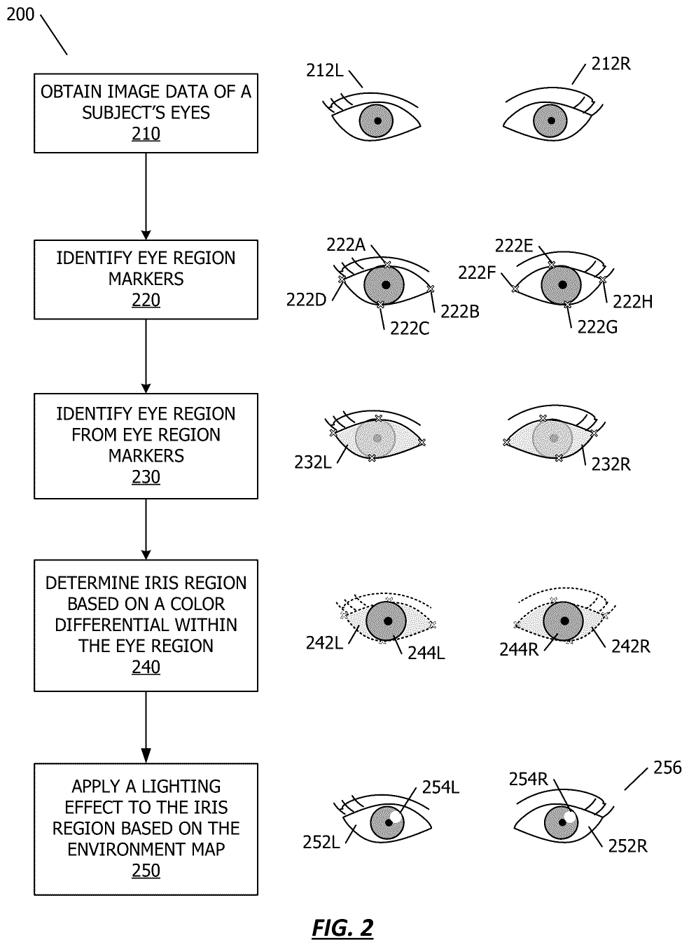

The flow diagram 100 continues to block 120, where a shape or geometry corresponding to an eye region is determined in the tracking data. According to one or more embodiments, the eye region may include a region 124 of image data 122 that includes an opening of the eye or eyes. For purposes of this disclosure, the term “eye region” may include the region for one or both eyes, and may include a continuous region, or two separate sub-regions, each corresponding to one of the eyes. The eye region may be determined in a number of ways. For example, semantic segmentation can be used to identify a region of the image data captured from tracking data that includes an opening of the eyes. As another example, as will be described in FIG. 2, feature detection can be used to identify landmarks, such as the semantic markers provided by the tracking data, to determine a region of the image data corresponding to the eye opening.

The flow diagram 100 continues to block 130, where a viewing direction 132 of the user 112 is determined. According to one or more embodiments, the viewing direction may be determined from tracking data captured at block 110. As an example, the viewing direction 132 may be determined based on eye tracking data. For example, a user's eyes may be tracked by one or more eye tracking sensors to determine a gaze vector. Additionally, or alternatively, the viewing direction of the user may be determined based on device sensors within device 114, such as accelerometers, gyroscopes, and the like. For example, if the device is a head-mounted device, then the pose of the device may be considered as a substitute for the user 112. Alternatively, the pose information for the device 114 may be used to supplement other pose data to determine a pose of the user.

At block 140, a lighting map 144 for an environment is obtained. The environment map may be associated with a scene with a particular lighting. The lighting map 144 may represent brightness, color, and/or other characteristics related to lighting in a scene, and may be any kind of digital representation of lighting of an environment. According to some embodiments, the lighting map 144 may be generated during runtime, or may be predefined. Further, the lighting map 144 may represent a particular environment in which the subject is present, in which the representation of the subject is to be presented, or some combination thereof. For example, device 114 may include sensors such as cameras, ambient light sensors, or the like, which can capture sensor data to determine a distribution of brightness from light sources in the environment. In some embodiments, the lighting map may be a dynamic lighting map that reflects the lighting in an environment based on placement of virtual content that emits light. For example, the lighting map may include lighting characteristics from user interface windows, virtual light emitters, or other components which may affect lighting of an environment in which the representation of the user is presented. Further, the lighting map may alternatively, or additionally, be based on lighting characteristics of a real world environment in which the representation of the user is to be presented, such as lighting characteristics of a receiving device at which another person is viewing the virtual representation of the user.

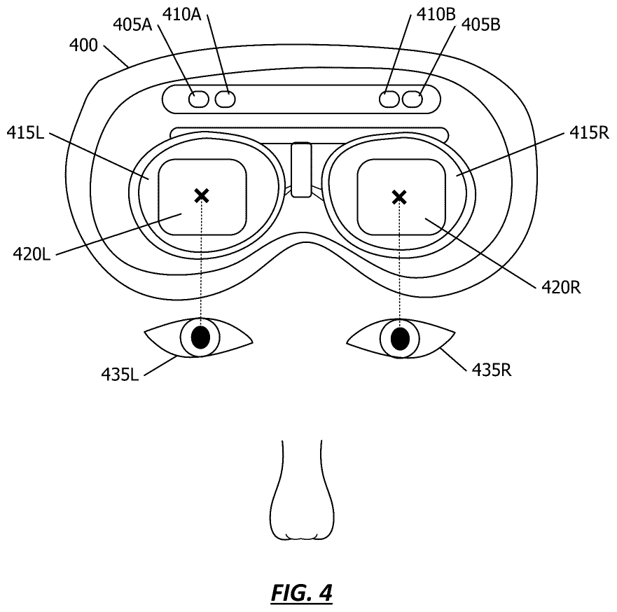

In some embodiments, the device 114 may be an enclosed device, such as a head mounted device with light shields. To that end, the lighting map may be generated based on the lighting within the head-mounted device. Turning to FIG. 4, an example diagram of a headset is shown, in accordance with one or more embodiments. A front view of a headset is presented as headset 400, along with the relative position of the headset 400 to the user's left eye 435L, right eye 435R. Further, in some embodiments, the lighting map may be based on lighting characteristics of multiple environments. As an example, the lighting within the head-mounted device may be combined with lighting characteristics of an additional environment, such as a physical or virtual environment in which the virtual representation of the user is to be presented.

The headset 400 may include numerous components which affect the lighting on the eyes 435L and 435R. The headset 400 may include a left optical module 415L and a right optical module 415R. The left optical module 415L may include a left display 420L. Similarly, the headset 400 may include a right optical module 415R. The right optical module 415R may include a right display 420R. When worn by the user, the light from left display 420L may bounce off left eye 435L, while the light from right display 420R may bounce off right eye 435R. Further, the device 400 may include one or more sensors configured to capture sensor data of the users' eyes. As shown, one example set up is a set of emitters 405A and 405B which are configured to emit light toward an eye for use in eye tracking. For example, emitters 405A and 405B may emit light to illuminate the eyes. Images of the eyes may then be captured by cameras 410A and 410B for use in eye tracking. As a result, the light from the emitters 405A and 405B may contribute to a lighting map of the environment within the device 400 when worn by a user.

At block 150, a lighting effect is applied to the eye region based on the lighting map. In some embodiments, the environment map is reflected onto the eye region. For example, a determination may be made based on a pose of the head, which portion of the lighting map (i.e., a target region) should be reflected back onto the eye region, as shown in eye region 154 of image data 152. Further, in some embodiments, gaze information may be considered in determining a specific viewing direction of the eye. According to some embodiments, rather than reflecting back the lighting map onto the eye region, a lighting effect may be applied in accordance with the target region of the lighting map. For example, a brightness for a corresponding region on the eye may be adjusted in accordance with the target region of the lighting map.

Further, in some embodiments, the lighting effect may only be applied to a particular portion of the eye, such as an iris region. FIG. 2 shows an example flow diagram of a technique for applying a lighting effect to an iris region of a virtual representation of the eyes of the subject, in accordance with one or more embodiments. Although the various processes and diagrams depicted in FIG. 2 are illustrated in a particular order, it should be understood that the various processes described may be performed in a different order. Further, not all the various processes may be necessary to be performed to train the mesh and texture encoders and decoders or obtain lighting representations.

The flow diagram 200 begins with block 210, where image data of a subject's eyes is obtained. According to one or more embodiments, image data may be captured for each eye, such as left eye 212L and right eye 212R. In some embodiments, the image data may be captured by one or more user-facing cameras. For example, returning to FIG. 4, a set of cameras including camera 410A and camera 410B may be situated in a head mounted device to capture images of a user's eyes. Thus, in some embodiments, the image data may be captured from a single camera, or from multiple cameras.

Returning to FIG. 2, the flow diagram 200 continues to block 220, where eye region markers are identified. As described above, in some embodiments, the eye region markers may be obtained as part of tracking data, and may identify landmarks on a user's face corresponding to the outline of the opening of the eye or eyes. In the current example, markers 222A, 222B, 222C, and 222D correspond to markers of a left eye 212L. In particular, marker 222A indicates a location of a top of the eye opening. Marker 222B indicates an inner corner of the eye opening. Marker 222C indicates a lower edge of the eye location. Marker 222D indicates an outer corner of the opening of the left eye 212L. Similarly, markers 222E, 222F, 222G, and 222H correspond to markers of a right eye 212R. In particular, marker 222E indicates a location of a top of the eye opening. Marker 222F indicates an inner corner of the eye opening. Marker 222G indicates a lower edge of the eye location. Marker 222H indicates an outer corner of the opening of the right eye 212R.

In some embodiments, the markers may be obtained using a feature identification process in the image data containing the eyes. Additionally, or alternatively, the markers may be obtained from a process for capturing characteristics of the user's face to be used in generating a persona, or a virtual representation of the user. For example, for each frame of sensor data from subject images, a height field displacement map may be generated corresponding to the face and provide RGB values, along with depth values and alpha values from which characteristics of the user can be translated into a persona representation. According to some embodiments, the depth map may include additional information, such as location of certain features of the user in the form of semantic markers. Thus, the semantic markers from the depth map may be translated to the image data to identify a location of the markers in the captured image data. Although four markers are shown per eye, alternate embodiments include obtaining different numbers of markers per eye.

The flow diagram 200 continues to block 230, where the eye region is identified from the eye region markers. According to one or more embodiments, a region for each eye may be determined based on the markers. Each of the markers may be associated with location information. The location information may be a 2D location corresponding to a displayed location of the eye, or a 3D location representative of the physical location of the characteristics associated with the landmark in the physical environment. According to one or more embodiments, an interpolation technique can be applied to the locations of the markers to determine boundaries of an eye region. As shown in the example diagram, a left eye region 232L and a right eye region 232R are determined. The shapes of left eye region 232L and a right eye region 232R are determined in accordance with the interpolation technique applied to the corresponding markers. According to some embodiments, errors may arise during the interpolation, which can be compensated for by contracting the boundary inward toward the eye opening.

At block 240, an iris region is determined based on a color differential within the eye region. According to one or more embodiments, the pixels in the image data that lie within the eye region may be analyzed for a color differential. In some embodiments, a color differential between two sets of pixels may be used to identify a region of the iris within the eye region. That is, because a color of the iris and the color of the sclera will differ, a differential in the color within the eye region can be used to identify the iris. As shown, the left eye region 232L may include an iris region 244L and a remainder of the eye region, corresponding to a sclera region 242L. Similarly, the right eye region 232R may include an iris region 244R and a remainder of the eye region, corresponding to a sclera region 242R.

The flowchart concludes at block 250, where a lighting effect is applied to the iris region of a virtual representation of the subject based on an environment map. As described above with respect to FIG. 1, the lighting effect may be applied by determining a pose of the head or gaze of the subject, and reflecting the environment map onto the eye region accordingly. For example, a determination may be made based on a pose of the head, which portion of the lighting map (i.e., a target region) should be reflected back onto the eye region. According to some embodiments, rather than reflecting back the lighting map onto the eye region, a lighting effect may be applied in accordance with the target region of the lighting map. For example, a brightness for a corresponding region on the eye may be adjusted in accordance with the target region of the lighting map.

In some embodiments, the lighting effect may be applied only to the iris region of the virtual representation of the eyes. As an example, a brightness can be applied only to the iris region in accordance with the lighting map. Further, in some embodiments, the lighting effect may be applied to both the sclera region and the iris region of the virtual representation of the eyes. For instance, the light effect may be applied differently to the sclera region than to the iris region of the virtual representation of the eyes. As an example, a brightness can be applied in accordance with the lighting map with more intensity in the iris region than the sclera region. As shown in the example diagram, a virtual representation eye region 256 is shown which includes a lighting treatment applied to the left iris region 254L and right iris region 254R, but not to the left sclera region 252L and right sclera region 252R.

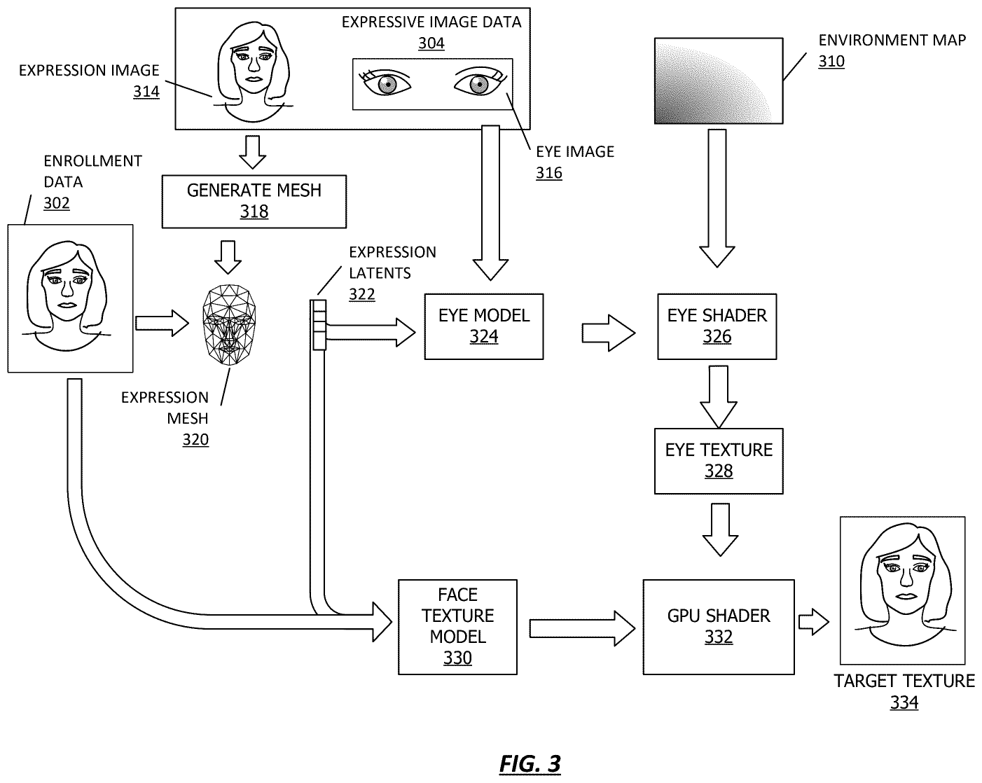

As described above, the generation of the virtual representation of the iris may be performed as part of a technique for generating a persona of a subject. FIG. 3 shows, in flow diagram form, a technique for generating a target texture, in accordance with one or more embodiments. The particular components and flow of the flow diagram is intended to provide an example embodiment and is not intended to limit the application.

The flow diagram begins at 302 where enrollment images are received. The enrollment data may include, for example, image data of the user which can be used to generate a persona of the user. The enrollment data may be captured from an enrollment process during which a device captures sensor data of a user performing one or more expressions. The enrollment data may be captured from the same sensors used during runtime to track user expressions, or may be captured by different sensors. For example, in some embodiments, the enrollment process is performed by a user holding a device in front of them such that the enrollment images are captured by cameras which typically face away from the user when the device is worn, such as scene cameras. The enrollment images may include images of the face in general, and/or the eye region such that a virtual representation of the eye region can be generated during runtime.

During runtime of a communication session expressive image data 304 is obtained. For example, image data of a face of a user 314 may be captured for each frame during the communication session. In some embodiments, additional eye image data 316 may be captured. From the image data, a mesh is generated at 318, for example from a trained network. The resulting mesh 320 may be applied to an expression model to obtain a set of expression latents 322. The set of expression latents provide a compact representation of the geometry of a user's face for a particular expression for a given frame. In some embodiments, the expression latents 322 may be used alone or in conjunction with enrollment data 302 to generate a face texture model 330. The face texture model may provide a virtual representation of the texture of the persona based on the current expression image.

According to some embodiments, the eye model 324 can be trained to identify an eye region and, optionally, an iris region within the eye region. As such, eye model 324 may utilize the eye image data 316 to determine the eye region and/or the iris region. In some embodiments, the eye region and/or iris region may be determined using feature detection or semantic segmentation. Alternatively, the eye region and/or iris region may be determined by obtaining markers for landmarks indicative of an opening of the eye, from which the eye opening can be identified. According to some embodiments, application of the eye model may be part of face tracking, as described above with respect to block 110 of FIG. 1. Alternatively, application of the eye model may be a separate process.

According to one or more embodiments, an environment map 310 may be provided. As described above, the environment map may correspond to a lighting map for a physical environment in which the subject is located, a physical or virtual environment in which the persona of the subject is to be presented, or the like. For example, the lighting map may provide a representation of light within the environment. An eye shader 326 may be used to apply a lighting treatment to an eye region or an iris region identified by the eye model 324. The lighting effect may be applied by determining a pose of the head or gaze of the subject, and reflecting the environment map onto the eye region accordingly. For example, a determination may be made based on a pose of the head, which portion of the lighting map (i.e., a target region) should be reflected back onto the eye region. According to some embodiments, rather than reflecting back the lighting map onto the eye region, a lighting effect may be applied in accordance with the target region of the lighting map. For example, a brightness for a corresponding region on the eye may be adjusted in accordance with the target region of the lighting map.

In some embodiments, the lighting effect may be applied only to the iris region of the virtual representation of the eyes. As an example, a brightness can be applied only to the iris region in accordance with the lighting map. Further, in some embodiments, the lighting effect may be applied differently to the sclera region than to the iris region of the virtual representation of the eyes. As an example, a brightness can be applied in accordance with the lighting map with more intensity in the iris region than the sclera region.

According to one or more embodiments, a GPU shader 332 can generate a target texture 334 by combining the eye texture 328 with the generated face texture model 330. For example, the brightness treatment for the eye texture can be applied by the GPU shader 332 at a detected iris region. As another example, the eye region, or iris region, may be generated as a separate texture and combined with the face texture by GPU shader 332. The target texture 334 may then be used to render a persona or other virtual representation of the subject by combining the texture with a geometric representation of the subject.

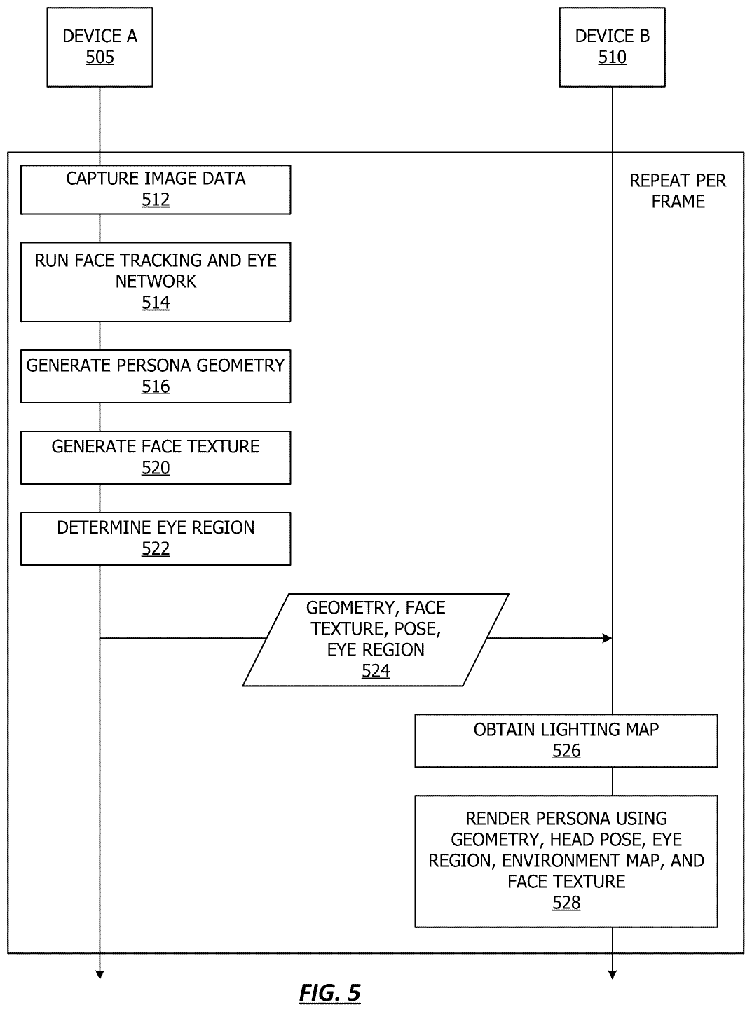

Embodiments described herein can be used during a multiuser communication session, in which users on separate devices communicate with each other. During the communication session, the remote user may be represented by a persona. FIG. 5 shows a flow diagram of a technique for rendering a persona in a multiuser communication session, in accordance with one or more embodiments. Although the various processes are described as being performed by particular devices, it should be understood that in alternative embodiments, one or more of the processes may be performed by additional and/or alternative devices. Further, the distribution of the performance of the various processes may vary. For example, some processes shown as being performed by a sender device may be performed by a receiver device.

The flow diagram begins at 512 where, for each frame during the communication session, Device A 505 may capture image data. The image data may include one or more images captured by a camera directed toward the user and, in particular, the eyes of the user. The image data may include one or more images capturing all and/or part of a user's face. At 514, Device A 505 can run tracking algorithms, including, for example, face tracking and eye tracking. The face tracking and eye tracking functionality may include, for example, applying the captured image data to various models to obtain information about the user. In some embodiments, the tracking algorithms may be used to determine a pose of the user's head in a particular environment. As described above, the eye network may provide eye tracking information, such as gaze direction and the like. According to some embodiments, the eye network may be part of face tracking. That is, rather than running a separate eye network, the face tracking network may include the functionality of the eye tracking network. Alternatively, face tracking and eye tracking may be implemented as separate processes.

Based on the tracking information, the flow continues at block 516 and a persona geometry is generated by Device A 505. According to one or more embodiments, the persona geometry may be generated based on tracking data and, optionally, enrollment data for a particular user. The geometry may be in the form of a 3D mesh, point cloud, or other three-dimensional representation of the shape of the user.

At block 520, Device A 505 generates a face texture. The face texture may be a representation of the appearance of the face. The face texture may be generated in a number of ways. In some embodiments, the face texture is generated. In some embodiments, the geometry and texture may be generated in a single representation. For example, representation of the user may be generated in the form of a depth map. According to some embodiments, depth map may include a height field displacement map. The height field displacement map may be based on RGBDA images (e.g., red-green-blue-depth-alpha images). However, in some embodiments, rather than a traditional depth image (i.e., RGBDA image), which define content depth relative to a single camera location, depths may be defined as portions of a face relative to multiple points on a surface of a planar shape, such as a cylindrical shape, partial cylindrical shape, or other curved 3D shape configured to overlay the face of a subject.

According to one or more embodiments, Device B 510 can receive the virtual representation data, such as geometry, face texture, pose, and indication of the eye region from Device A 505, as shown at block 524 to generate the persona. The indication of the eye region may include, for example, coordinates of the geometry and/or texture at which the eyes and/or irises are located. At block 526, Device B 510 obtains a lighting map. According to one or more embodiments, the lighting map may be obtained from Device A 505, may be generated locally by Device B 510, or may be obtained from another source. According to one or more embodiments, the lighting map may be associated with a scene with a particular lighting. The lighting map may represent brightness, color, and/or other characteristics related to lighting in a scene, and may be any kind of digital representation of lighting of an environment. According to some embodiments, the lighting map may be generated during runtime by Device A 505 and/or Device B 510, or may be predefined, for example if the persona is to be presented in a virtual environment. Further, in some embodiments, multiple lighting maps may be obtained. This may occur, for example, if a user has local light from a local environment affecting the appearance of their eye, and is being presented in a secondary environment having different lighting that affects the appearance of the eye. By considering multiple lighting maps, the persona can be rendered to appear as they would with their local lighting in combination with the remote lighting, for example.

At block 528, a persona is rendered based on the geometry, texture, head pose, eye region, and environment map. In particular, as described above, a persona may be generated using the geometry and texture. A lighting treatment may be applied to a portion comprising the eye region to adjust a brightness on a portion of the eye or iris of the persona based on the lighting map. The final persona may then be presented at Device B 510.

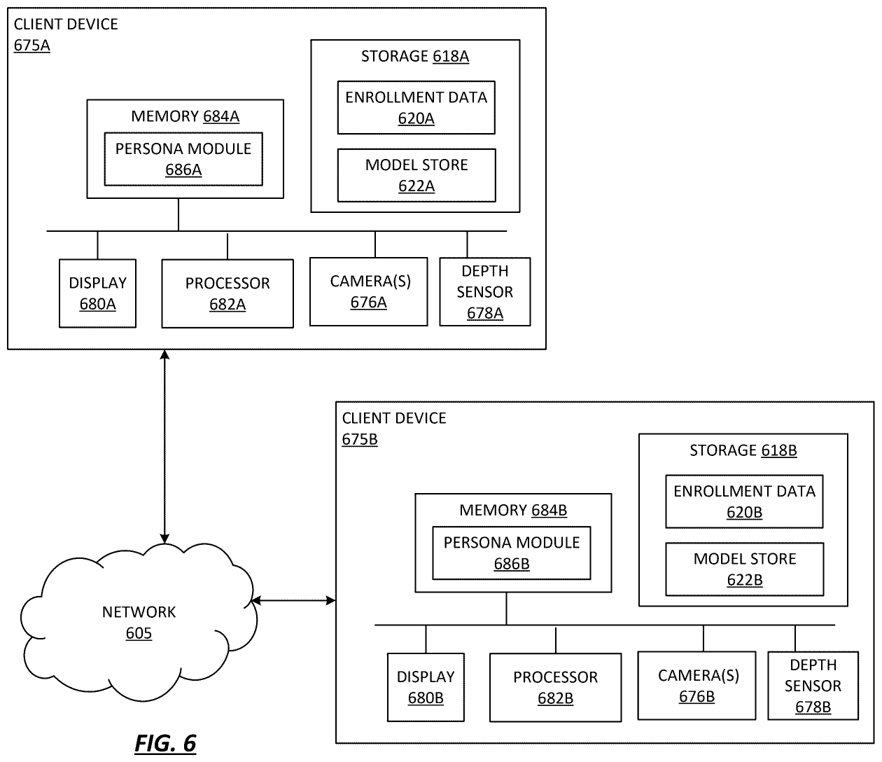

FIG. 6 shows, in block diagram form, a multifunction electronic device, in accordance with one or more embodiments. A simplified block diagram of a client device 675A is depicted, communicably connected to a client device 675B, in accordance with one or more embodiments of the disclosure. Client device 675A and client device 675B may each be part of a multifunctional device, such as a mobile phone, tablet computer, personal digital assistant, portable music/video player, wearable device, base station, laptop computer, desktop computer, network device, or any other electronic device. Client device 675A may be connected to the client device 675B across a network 605. Illustrative networks include, but are not limited to, a local network such as a universal serial bus (USB) network, an organization's local area network, and a wide area network such as the Internet. According to one or more embodiments, client device 675A and client device 675B may participate in a communication session in which each device may render an avatar of a user of the other client device.

Each of client device 675A and client device 675B may include a processor, such as a central processing unit (CPU), 682A and 682B. Processor 682A and processor 682B may each be a system-on-chip such as those found in mobile devices and include one or more dedicated graphics processing units (GPUs). Further, each of processor 682A and processor 682B may include multiple processors of the same or different type. Each of client device 675A and client device 675B may also include a memory 684A and 684B. Each of memory 684A and memory 684B may include one or more different types of memory, which may be used for performing device functions in conjunction with processors 682A and 682B. For example, each of memory 684A and memory 684B may include cache, ROM, RAM, or any kind of transitory or non-transitory computer-readable storage medium capable of storing computer-readable code. Each of memory 684A and memory 684B may store various programming modules for execution by processors 682A and 682B, including persona modules 686A and 686B. Each of client device 675A and client device 675B may also include storage 618A and 618B. Each of storage 618A and 618B may include one more non-transitory computer-readable mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Each of storage 618A and 618B may include enrollment data 620A and 620B and model store 622A and 622B.

Each of client device 675A and client device 675B may also include one or more cameras 676A and 676B or other sensors, such as depth sensor 678A and depth sensor 678B, from which depth of a scene may be determined. In one or more embodiments, each of the one or more cameras 676A and 676B may be a traditional RGB camera or a depth camera. Further, each of the one or more cameras 676A and 676B may include a stereo- or other multi-camera system, a time-of-flight camera system, or the like which capture images from which depth information of a scene may be determined. Each of client device 675A and client device 675B may allow a user to interact with extended reality (XR) environments. There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display device 680A and 680B may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

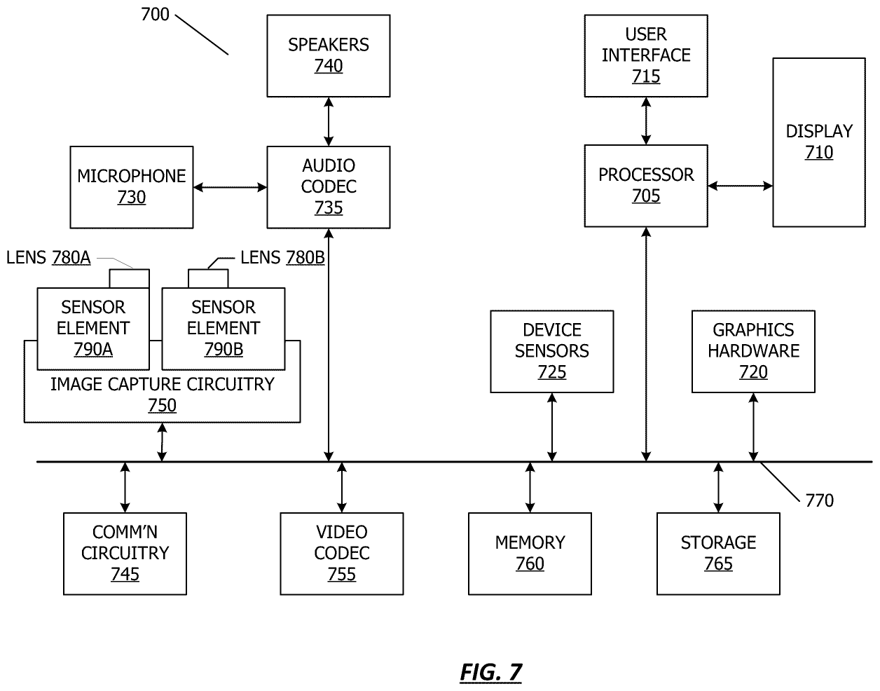

Referring now to FIG. 7, a simplified functional block diagram of illustrative multifunction electronic device 700 is shown, according to one embodiment. Each of electronic devices may be a multifunctional electronic device or may have some or all of the described components of a multifunctional electronic device described herein. Multifunction electronic device 700 may include processor 705, display 710, user interface 715, graphics hardware 720, device sensors 725 (e.g., proximity sensor/ambient light sensor, accelerometer, and/or gyroscope), microphone 730, audio codec(s) 735, speaker(s) 740, communications circuitry 745, digital image capture circuitry 750 (e.g., including camera system), video codec(s) 755 (e.g., in support of digital image capture unit), memory 760, storage device 765, and communications bus 770. Multifunction electronic device 700 may be, for example, a digital camera or a personal electronic device such as a personal digital assistant (PDA), personal music player, mobile telephone, or a tablet computer.

Processor 705 may execute instructions necessary to carry out or control the operation of many functions performed by device 700 (e.g., such as the generation and/or processing of images as disclosed herein). Processor 705 may, for instance, drive display 710 and receive user input from user interface 715. User interface 715 may allow a user to interact with device 700. For example, user interface 715 can take a variety of forms, such as a button, keypad, dial, click wheel, keyboard, display screen, and/or a touch screen. Processor 705 may also, for example, be a system-on-chip such as those found in mobile devices and include a dedicated graphics processing unit (GPU). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include two (or more) lens assemblies 780A and 780B, where each lens assembly may have a separate focal length. For example, lens assembly 780A may have a short focal length relative to the focal length of lens assembly 780B. Each lens assembly may have a separate associated sensor element 790. Alternatively, two or more lens assemblies may share a common sensor element. Image capture circuitry 750 may capture still and/or video images. Output from image capture circuitry 750 may be processed, at least in part, by video codec(s) 755 and/or processor 705 and/or graphics hardware 720, and/or a dedicated image processing unit or pipeline incorporated within image capture circuitry 750. Images so captured may be stored in memory 760 and/or storage 765.

Image capture circuitry 750 may capture still and video images that may be processed in accordance with this disclosure, at least in part, by video codec(s) 755 and/or processor 705 and/or graphics hardware 720, and/or a dedicated image processing unit incorporated within image capture circuitry 750. Images so captured may be stored in memory 760 and/or storage 765. Memory 760 may include one or more different types of media used by processor 705 and graphics hardware 720 to perform device functions. For example, memory 760 may include memory cache, read-only memory (ROM), and/or random access memory (RAM). Storage 765 may store media (e.g., audio, image, and video files), computer program instructions or software, preference information, device profile information, and any other suitable data. Storage 765 may include one more non-transitory computer-readable storage mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Memory 760 and storage 765 may be used to tangibly retain computer program instructions or code organized into one or more modules and written in any desired computer programming language. When executed by, for example, processor 705, such computer program code may implement one or more of the methods described herein.

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (similar to contact lenses), headphones/earphones, speaker arrays, input systems (e.g., wearable or handheld controllers with or without haptic feedback), smartphones, and tablets.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system- and business-related constraints), and these goals may vary from one implementation to another. It will also be appreciated that such development efforts might be complex and time-consuming but would nevertheless be a routine undertaking for those of ordinary skill in the design and implementation of graphics modeling systems, having the benefit of this disclosure.

The present disclosure recognizes that the use of such personal information data, in the present technology, can be used to the benefit of users. For example, the personal information data can be used to generate virtual representations of a user in the form of a persona. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA), whereas health data in other countries may be subject to other regulations and policies and should be handled accordingly. Hence, different privacy practices should be maintained for different personal data types in each country.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions or the arrangement of elements shown should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining tracking data for a subject comprising a set of markers associated with an eye region;
obtaining, for each eye of a subject, an iris region based on the set of markers associated with the eye region;
determining a viewing direction of the subject;
obtaining a lighting map for an environment; and
generating virtual representation data for a virtual representation of the subject by applying a lighting effect to the iris region in accordance with the lighting map and the viewing direction.

2. The method of claim 1, wherein obtaining the iris region comprises:
determining an eye region based on the set of markers, wherein the set of markers correspond to a set of points on the eye opening, wherein the set of markers are each associated with location information; and
identifying the iris region within the eye region based on a color differential among pixels in image data comprising the eye region.

3. The method of claim 1, wherein the environment corresponds to an environment in which the virtual representation of the subject is to be presented.

4. The method of claim 1, wherein the environment corresponds to a physical environment in which the subject is located.

5. The method of claim 1, lighting effect is further applied in accordance with an additional lighting map for an additional environment.

6. The method of claim 1, wherein the lighting effect comprises adjusting a brightness to one or more regions of the eye of a virtual representation of the subject in accordance with the lighting map.

7. The method of claim 1, wherein the lighting effect comprises reflecting a portion of the lighting map onto the iris region in accordance with the viewing direction.

8. A non-transitory computer readable medium comprising computer readable code executable by one or more processors to:
obtain tracking data for a subject comprising a set of markers associated with an eye region;
obtain, for each eye of a subject, an iris region based on the set of markers associated with the eye region;
determine a viewing direction of the subject;
obtain a lighting map for an environment; and
generate virtual representation data for a virtual representation of the subject by applying a lighting effect to the iris region in accordance with the lighting map and the viewing direction.

9. The non-transitory computer readable medium of claim 8, wherein the computer readable code to obtain the iris region comprises computer readable code to:
determine an eye region based on the set of markers, wherein the set of markers correspond to a set of points on the eye opening, wherein the set of markers are each associated with location information; and
identify the iris region within the eye region based on a color differential among pixels in image data comprising the eye region.

10. The non-transitory computer readable medium of claim 8, wherein the environment corresponds to an environment in which the virtual representation of the subject is to be presented.

11. The non-transitory computer readable medium of claim 8, wherein the environment corresponds to a physical environment in which the subject is located.

12. The non-transitory computer readable medium of claim 8, lighting effect is further applied in accordance with an additional lighting map for an additional environment.

13. The non-transitory computer readable medium of claim 8, wherein the set of markers are obtained from sensor data captured by one or more sensors of a device worn by the subject, and
wherein the virtual representation data is generated based on the tracking data.

14. The non-transitory computer readable medium of claim 8, wherein the lighting effect comprises adjusting a brightness to one or more regions of the eye of a virtual representation of the subject in accordance with the lighting map.

15. The non-transitory computer readable medium of claim 8, further comprising computer readable code to:
apply an additional lighting effect to a portion of the virtual representation of the subject comprising an eye region and excluding the iris region.

16. The non-transitory computer readable medium of claim 8, wherein the viewing direction is determined based on a head pose.

17. The non-transitory computer readable medium of claim 8, wherein the viewing direction is determined based on a gaze vector.

18. A system comprising:
one or more processors; and
one or more computer readable media comprising computer readable code executable by the one or more processors to:
obtain tracking data for a subject comprising a set of markers associated with an eye region;
obtain, for each eye of a subject, an iris region based on the set of markers associated with the eye region;
determine a viewing direction of the subject;
obtain a lighting map for an environment; and
generate virtual representation data for a virtual representation of the subject by applying a lighting effect to the iris region in accordance with the lighting map and the viewing direction.

19. The system of claim 18, wherein the computer readable code to obtain the iris region comprises computer readable code to:
determine an eye region based on the set of markers, wherein the set of markers correspond to a set of points on the eye opening, wherein the set of markers are each associated with location information; and
identify the iris region within the eye region based on a color differential among pixels in image data comprising the eye region.

20. The system of claim 18, wherein the lighting effect comprises adjusting a brightness to one or more regions of the eye of a virtual representation of the subject in accordance with the lighting map.
